(19) United States
(12) Patent Application Publication
(10) Pub. No.: US 2005/0222881 A1
(43) Pub. Date: Oct. 6, 2005

(54) Management work system and method

(76) Inventor: Garry Booker, Tulsa, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 10/818,143

(22) Filed: Apr. 5, 2004

(51) Int. Cl. G06F 17/60

(52) U.S. Cl. 705/7

(57) ABSTRACT

The present invention provides for a system and method for managing work including a two-dimensional display depicting work performance data including cost performance, technical performance, and schedule performance. The work performance data includes project work and non-project work. Further, the two-dimensional display can display the cost performance, technical performance, and schedule performance in a plurality of layers including a bottom layer representing budgeted cost for work scheduled, a middle layer representing budgeted cost for work performed; and a top layer representing actual cost for work performed.

### REFERENCE TO PENDING APPLICATIONS

This application is not based upon any pending domestic or international patent applications.

### REFERENCE TO MICROFICHE APPENDIX

This application is not referenced in any microfiche appendix.

### BACKGROUND OF THE INVENTION

1. Field of the Invention

The present invention is generally directed toward a management work system and method. More specifically, the present invention is directed toward a system and method for managing knowledge work.

2. Background

The ability of a business to be able to increase its productivity can provide a competitive advantage over competition. One source of increased productivity is to improve the management of a business's knowledge work.

In order to be able to manage knowledge work, one must understand the process flow requirements of how knowledge work by the various levels of a business. For example, the executive leadership view knowledge at a “forest level.” At this level, an executive can focus on the execution of business's purposes, including the business's people, strategy and operations. The management view knowledge work at a “tree level.” At this level, management manages projects, such as program plans, work breakdown structures and processes, operations, operations plans, operation manuals, operating accounts and processes. The individual knowledge worker views knowledge work at a “leaf level.” These individuals handle the tasks, work assignments, duties, initiatives, to-do lists, etc. There are two subtypes of knowledge work for the individual, completion tasks and level of effort tasks.

Knowledge is now the dominant form of work effort in the United States economy, and it is still growing. The manufacturing segment is on the decline. Non-professional service work is at best stable, but also is subject to automation and/or export which is otherwise known as “offshoring.”

Enterprise-wide project management is a relatively new concept, especially in commercial industries, yet the concept is growing steadily. However, the tools for this movement are difficult to standardize and even more difficult to integrate with one another.

Almost all work that is not primarily knowledge work falls under the supervision of knowledge workers, and therefore is subject to objective cost, technical and schedule performance measures. Most of these industries employ project resources and non-project resources that can and should be managed jointly and consistently. Earned value management is the integration and balance of cost management, technical management and schedule management.

Prior art techniques for displaying cost and schedule performance exist. They include the following:

Gantt Charts. The Gantt chart is a graphical representation of project schedules. An example of a Gantt chart is set forth in FIG. 1. The advantage with this type of chart is that they are simple to produce and require no training to understand. The disadvantages, however, are numerous. They are “information thin,” in that they communicate very little data per square inch of the display. This is demonstrated by project managers who resort to wall-sized Gantt charts for representing only a moderate sized project (often with detail lacking). The Gantt charts also do not communicate planned value, otherwise known as Budgeted Cost for Work Scheduled (BCWS), which is essential to understanding the relative size of tasks and how “burn rate” changes with time. The Gantt charts do not show earned value, otherwise known as Budgeted Cost for Work Performed (BCWP) or schedule variances relative to earned value. The best a Gantt Chart can accomplish is to show a horizontal percent-complete bar, which actually misrepresents progress if budgeted “bum rate” is not constant. This type of chart does not visualize cost performance, which is the heart of an Earned Value Management System (EVMS). Finally, Gantt charts are not useful for non-project work (i.e, on-going business operations.) This is because most operations accounts have a start and end dates corresponding, for example, to the start and end of a calendar year, and they do not show budgeted cost or actual cost.

Line Charts. Since the Gantt chart has so many weaknesses in representing Earned Value Management, other prior art EVM instruments utilize line charts. An example of a line chart is set forth in FIG. 2. The advantage of these line charts is that they are relatively easy to produce. Training a person to read them is not cost prohibitive. The disadvantages with this technique, again, are numerous. Line charts can depict the performance of only a single activity per chart. Similar to the Gantt Chart, this technique produced a very “information thin” representation. A typical organization has thousands of simultaneous tasks, which makes this type of display useful for only a few high level charts. This means the line charts are typically not available (or useful) to the individual knowledge worker who needs to understand and evaluate his or her own cost and schedule performance. This technique also has visualization problems. Unless line colors or line types are standardized, visualization of cost and schedule variances are not intuitive to the human eye. Further, showing schedule variances in dollar terms is a counter-intuitive notion and is not understood by most people. Finally, any changes in the performance measurement baseline (planned value as a function of time) may not be obvious from month to month.

CPI/SPI Charts. An additional technique is the use of displaying the cost performance index (CPI) and Schedule Performance Index (SPI) on the same chart. An example of this chart is set forth in FIG. 3. Although CPI is the heart of Earned Value Management, and is a valuable indicator, SPI, other the hand, is a poor indicator for several reasons. The SPI typically includes all tasks, not just those on the critical path. This defeats the purpose of managing schedule to the project's critical path. It is not commonly known that SPI is virtually useless in the final stages of a project (when schedule performance is critical). This weakness is not easily understood and is very rarely understood by executives and clients. For example, if a project is very late yet remains at 95% percent complete, SPI is computed at 0.95. A typical rule of thumb is that an SPI above 0.9 is considered acceptable. If the project is a year behind and the client is very unhappy about not receiving the final deliverable, a 0.95 SPI does NOT indicate the problem.

Thus, there is a need to provide a system which can manage cost and schedule performance measures in combination and provide an elegant visualization of complex EVMS data sets.

### BRIEF SUMMARY OF THE INVENTION

The present invention satisfies the needs stated above. The present invention is generally directed toward a management work system and method. More specifically, the present invention is directed toward a system and method for managing knowledge work and work processes.

Many millions of pages of work are dedicated to reporting the balance (equilibrium) of cost, technical and schedule performance. These reports are generated for work teams, for executive management and for clients. Many millions of hours are spent in meetings and in travel to report cost, technical and schedule status. Performing this effectively and efficiently on every knowledge worker's computer, instead of reports and meetings and travel has enormous commercial value.

The high bandwidth capacity of the human visual channel is well known. For example, without any cognitive load, a person can readily detect very subtle changes in a cluttered visual field. Unlike the prior art, the present invention takes significant advantage of the human visual channel. It does this by representing work as a fixed area, and modulating color or shading to represent the ever-changing balance of cost, technical and schedule performance.

A second advantage is that the present invention communicates a large volume of data with devices of limited resolution, such as a computer screen, projectors or even personal digital assistants (PDAs). This is an enormous advantage as organizations require greater attention to detail, and demand greater interactivity.

A third advantage is the ability to integrate performance data vertically in an organization. This means the invention is equally useful at the level of an organizations leader (e.g. CEO/President), at the project manager's level, and at the level of the individual knowledge worker. We call these levels the forest level, tree level, and leaf level of knowledge work.

A fourth advantage is that the invention is a highly intuitive solution to EVM's weakest metric, which is the Schedule Performance Index (SPI). An area of work that is behind schedule is easily spotted relative to the “today” line. Both the size of the area and the distance left of the today line are important visual cues in monitoring schedule performance, especially at the end of a project when SPI becomes useless.

A fifth advantage is the present invention's ability to represent the life cycle of a project as a motion picture. Changes in the balance of cost, technical and schedule performance are represented by color changes only, not by movement of lines. Changes in area only occur when a budget baseline is modified. A budget baseline change is a significant event in the life cycle of a project and often goes unnoticed by stakeholders or prime contractors. In the prior art, budget changes can require a dedicated and alert project analyst. This invention makes budget changes intuitive to even the untrained eye.

A sixth advantage is that the present invention is equally useful for project work (temporary and unique efforts) as it is for non-project operations work (ongoing or repetitive efforts). This can help reduce the organizational gaps that occur in many organizations between project-oriented staff and operations-oriented staff. It can also facilitate the organization-wide allocation of resources.

A seventh advantage is that the present invention has additional capacity to serve as an interactive GUI to the work itself, thereby putting greater emphasis on performance and execution. With further extensions (layers and colors), the invention can be used as an interface to manage deliverables, visualize risk, visualize project merit (akin to the “balanced scorecard” concept), and even encompass all knowledge generated in a volume of work.

One aspect of the present invention, a system for management work, is disclosed. In this aspect, a two-dimensional display depicting work performance data including cost performance and schedule performance is disclosed. This aspect can include, individually or in combination, project work and non-project work.

The two-dimensional display can show the cost performance and schedule performance as a plurality of layers. These layers include a layer representing budgeted cost for work scheduled, a layer representing budgeted cost for work performed and a layer representing actual cost for work performed. These layers can be layered such that the layer representing budgeted cost for work scheduled is a bottom layer, a layer representing budgeted cost for work performed is a middle layer and a layer representing actual cost for work performed is a top layer.

The budgeted cost for work scheduled is represented as an area chart as a function of time. Likewise, the budgeted cost for work performed is also represented as an area chart as a function of time which never exceeds the area of the budgeted cost for work scheduled. The area of the budgeted cost for work performed layer fills from left to right, with the right vertical edge representing the current achievement of Earned Value. By comparing the right edge of an element of work to the vertical “today line”, it is easy to see if the work is behind schedule, on schedule, or ahead of schedule. This is an intuitive and highly visual measure of schedule performance.

The layer representing actual cost is also an area chart which never exceeds the area of the budgeted cost of work performed. The area of the actual cost layer fills from bottom to top. The color or shading of the actual cost area is adjusted depending upon the actual cost as it relates to the budgeted cost for work performed. This allows for the ability to visually determine if the work is under budget, on budget or over budget. By layering all three layers in combination, this aspect of the present invention provides the ability for one to determine if work is on schedule and on budget or not.

In another aspect, the plurality of layers can be displayed as one or more constructs. The first construct is a segregated view of multiple sub-elements of work, which is analogous to drawing multiple area charts, stacked vertically. This is similar to a Gantt chart, but the vertical dimension of each horizontal bar indicates relative burn rate (budgeted burn rate) for each cost element. The second construct is an aggregated view of multiple sub-elements of work. This is a basic sand chart, or otherwise known as an area chart. The third construct is an integrated view of all sub-elements of work. This construct indicates cost and schedule performance at a higher (holistic) level.

In another aspect, the above system is implemented by a computer and software program executed by the computer. The software program and computer being operable in combination to receive various work performance data, including the cost performance relative to earned value and the schedule performance relative to earned value; and display the cost performance, the technical performance and the schedule performance in a single, integrated display. The computer and software program is operable to prepare the display as a plurality of layers as described above.

In another aspect, the present invention discloses a method for managing work including the steps of receiving various work performance data, including the cost performance relative to earned value and the schedule performance relative to earned value; and displaying, simultaneously, said cost performance and said schedule performance in a single, integrated display.

This aspect of the method of the present invention can include the work performance data having project work and non-project work, either in combination or individually.

Further, this aspect of the method of the present invention can include displaying the single, integrated display as a plurality of layers having a bottom layer representing budgeted cost for work scheduled, a middle layer representing budgeted cost for work performed and top layer representing actual cost for work performed, as set out above.

Further features of the present invention will be apparent to those skilled in the art upon reference to the accompanying drawings and upon reading the following description of the preferred embodiments.

### BRIEF DESCRIPTION OF THE DRAWINGS

FIG. 1 is a view of a prior art Gantt Chart.

FIG. 2 is a view of a prior art Line Chart.

FIG. 3 is a view of a prior art a CPI/SPI Chart.

FIG. 4A-E are perspective views of an embodiment 20 of the system of the present invention showing an aggregated view.

FIG. 5A-E are a perspective view of embodiment 20 in a segregated view.

FIG. 6A-E are a perspective view of embodiment 20 in an integrated view.

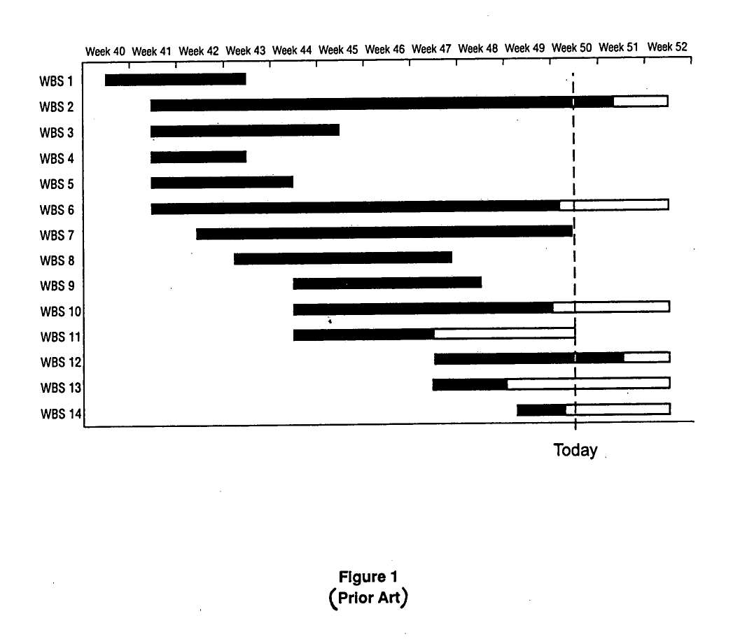

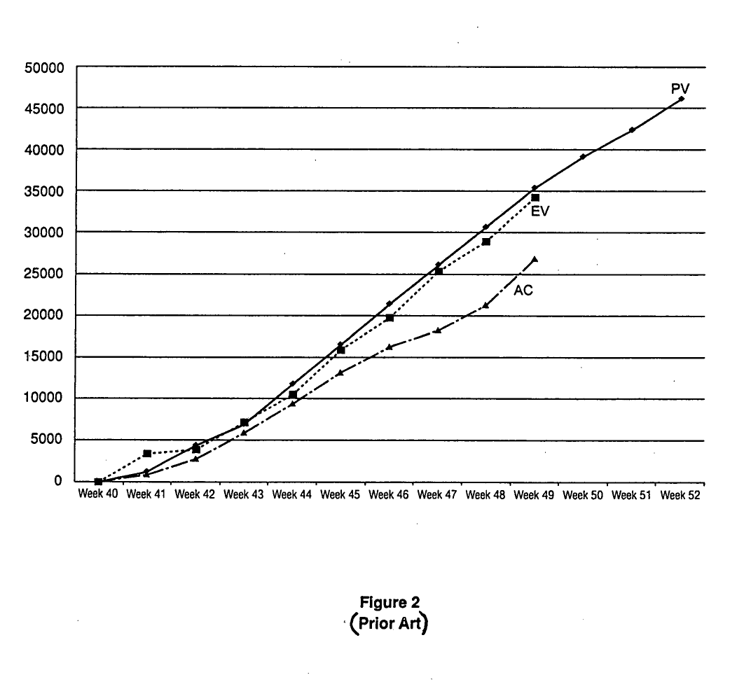

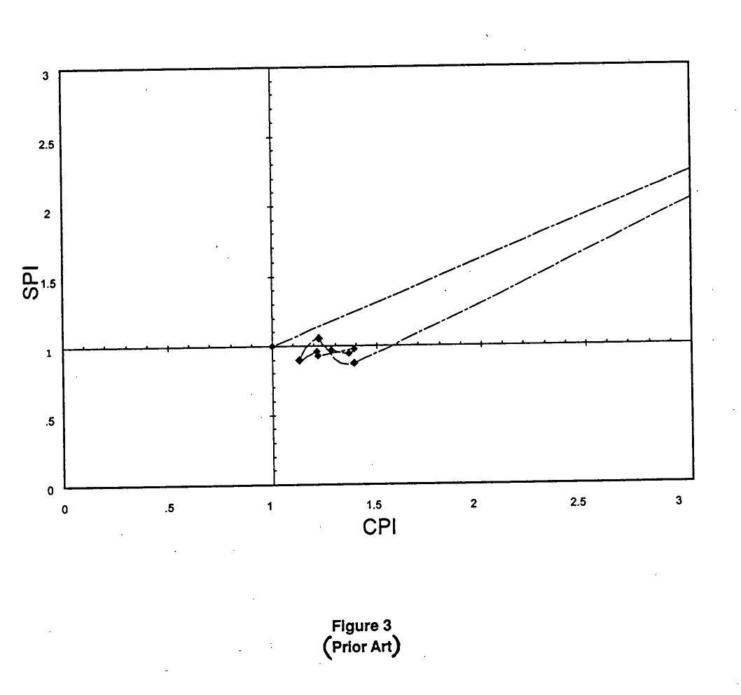

### DETAILED DESCRIPTION OF THE PREFERRED EMBODIMENTS

Before explaining the present invention in detail, it is to be understood that the invention is not limited to the preferred embodiments contained herein. The invention is capable of other embodiments and of being practiced or carried out in a variety of ways. It is to be understood that the phraseology and terminology employed herein are for the purpose of description and not of limitation.

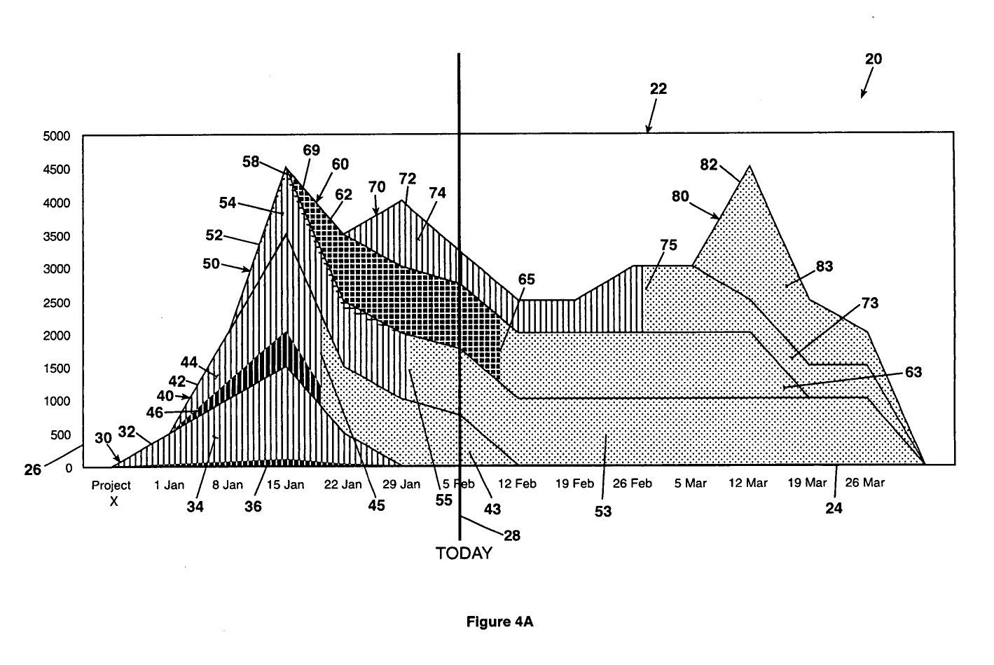

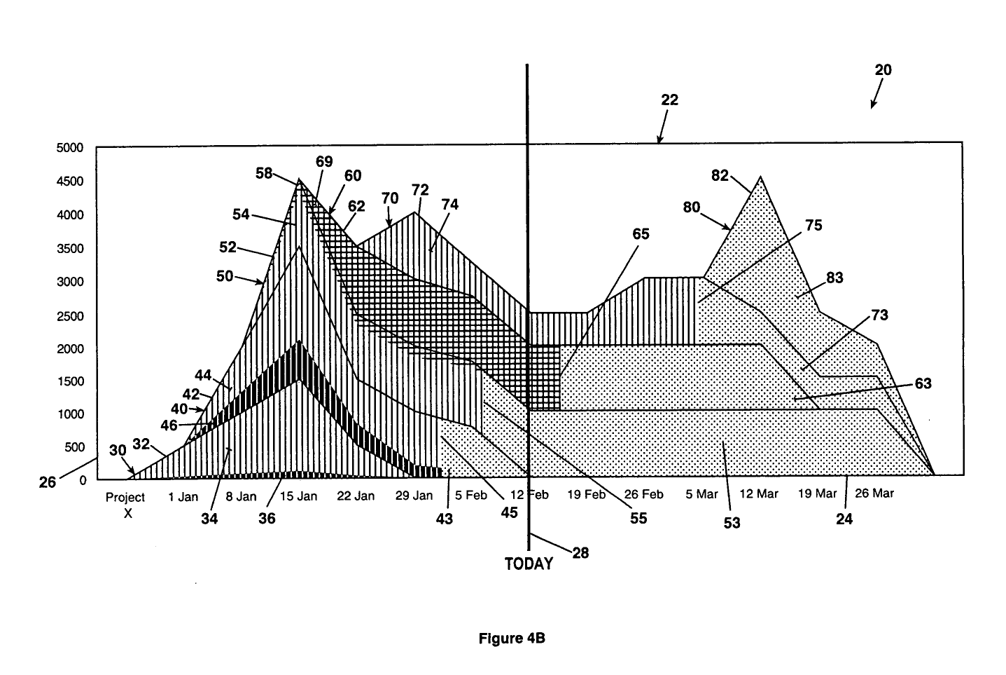

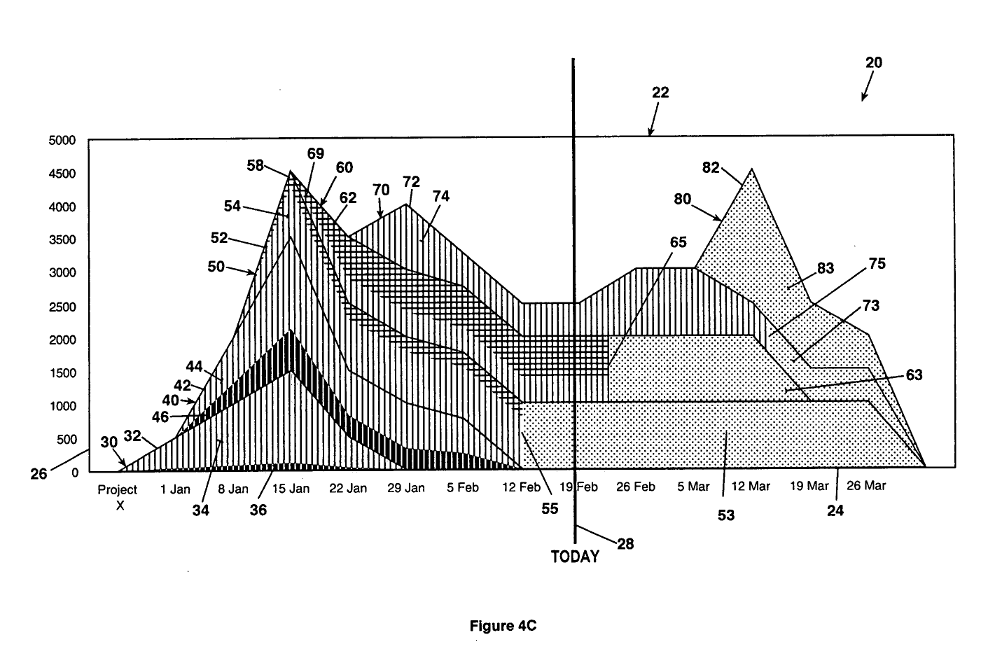

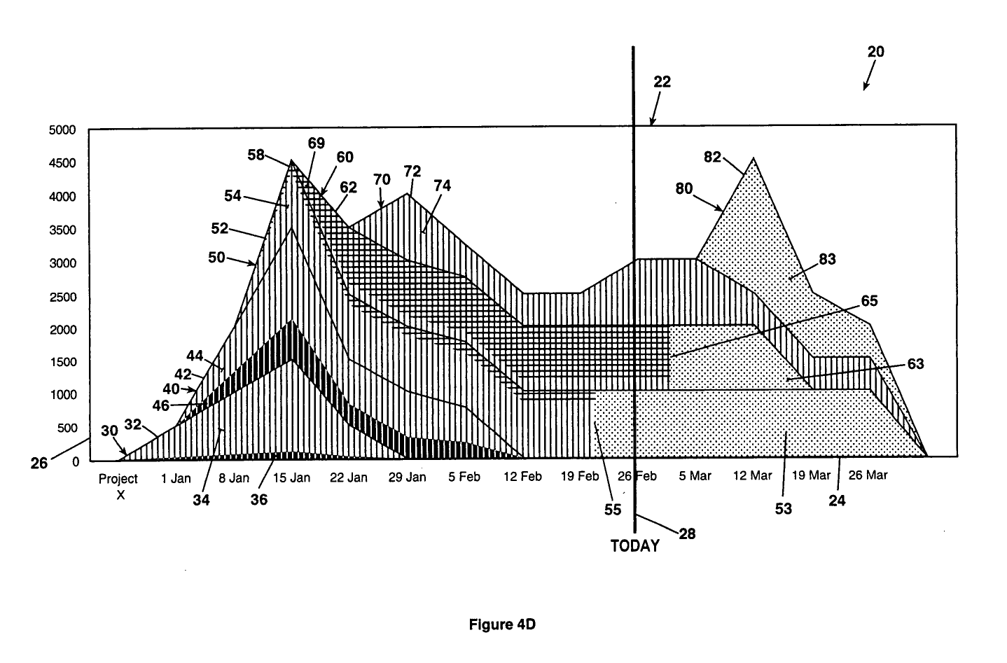

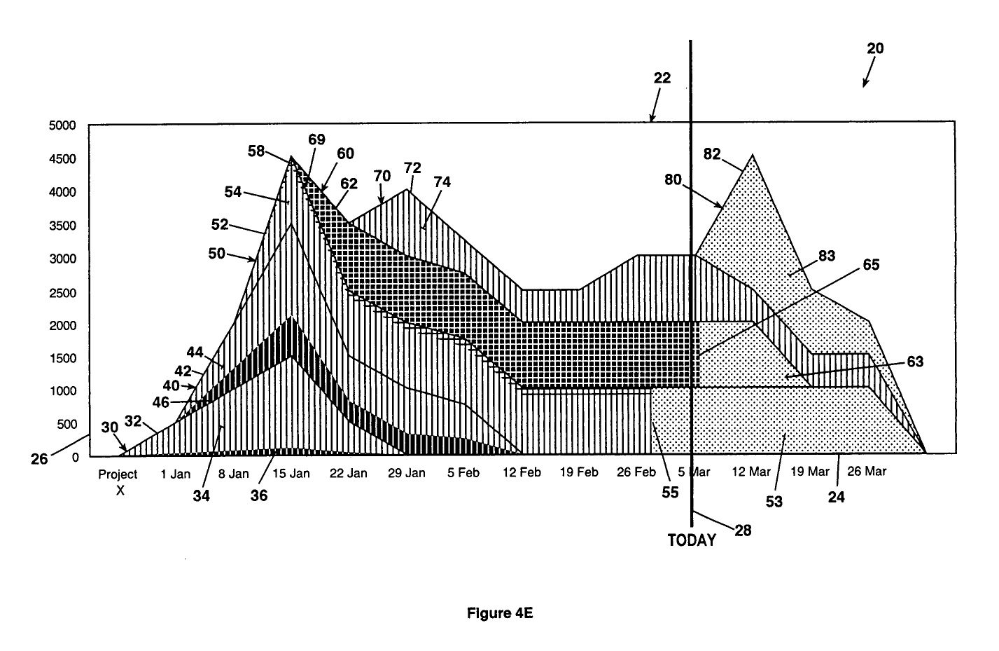

As illustrated in FIGS. 4A-E, an embodiment 20 of the system for managing work of the present invention is shown and generally illustrates a two-dimensional display 22 depicting work performance data which includes cost performance relative to earned value and schedule performance relative to earned value. The work performance data can include, individually or in combination, project work and non-project work. The two-dimensional display 22 includes an x-axis 24 representing a progression of time and a y-axis representing a total budget in dollars. A “today line” 28 is also included to identify the status of the performance data at a particular date in time.

In embodiment 20, the two-dimensional display 22 shows six projects 30, 40, 50,60, 70 and 80. Each project 30-80 is represented by an area chart of budgeted cost of work scheduled as a function of time. This is reflected in the FIGS. 4A-E by the numerals 32, 42, 52, 62, 72 and 82. In embodiment 20, each area chart 32-82 is specific for each individual project 30-80. As will be explained below, the area chart can also be represented as a total of all the projects in an integrated manner. Further, embodiment 20 identifies six projects as part of the two-dimensional display 22. One skilled in the art, however, would recognize that the present invention can include one or more projects. The use of six projects is merely for illustrative purposes and is not meant to be limiting.

The overall status of a project includes the cost performance relative to earned value, i.e. under budget, on budget or over budget; and the schedule performance relative to earned value, i.e. behind schedule, on schedule or ahead of schedule. Embodiment 20 allows a user to be able to visually determine the status of the cost performance and schedule performance as a function of time for each project. This is due to the various status levels of the cost performance and schedule performance having unique shadings, or colors. While this embodiment 20 utilizes particular shading effects, one skilled in the art can understand that other shading effects and color can be used. The use of these particular shading effects is merely illustrative and is not meant to be limiting.

The schedule performance relative to earned value of a project is completely enclosed within that project's area of budget costs of work scheduled. The schedule performance is represented by two conditions, the amount of work scheduled and the amount of work performed. Each of the two conditions has a unique shading or color. When a project has an amount of work scheduled but no performed work, the project's entire area is painted with the particular shading or color which represents the amount of work scheduled. As work is performed, the particular shading or color which represents the amount of work performed fills in the project's area from left to right. The amount of the area which is filled in is the percentage of work performed as compared to the total amount of work scheduled. As this occurs, the area reflects both the shading or colors representing both the amount of work scheduled and the amount of work performed. Once all the work scheduled for a project is completed, the entire area is painted with the particular shading or color representing the amount of work performed.

This is illustrated in embodiment 20. As shown in FIG. 4A, project 80 is completely painted with a particular shading 83. This shading represents the total amount of work scheduled for project 80. Since there is no other shading in project 80's area 82, one can visually recognize that no work has been performed on this project. Project 40 illustrates a project that has both work performed and work yet to be performed. The shading within project 40's area 42 represents both the amount of work scheduled 43 and the work performed 44. Based on the amount of work performed 44 as compared to the work scheduled 43, one can visually recognize that approximately fifty percent (50%) of the work scheduled for project 40 has been performed. In FIG. 4A, projects 50, 60 and 70 also illustrate projects that include work performed and work scheduled. Project 30, however, illustrates a project that has performed all of the scheduled work. Within project 30's area 32, only the shading representing the work performed 34 in shown therein. By only having this shading, one can visually recognize that all the work schedule for project 30 has been performed.

To determine the status of the performance of the scheduled work, one can compare the right edge of the shading of the work performed for a project with the today line 28. The area of the work performed fills from left to right within the project's area, with the right vertical edge representing the current achievement of Earned Value. By comparing the right edge of an element of work to the vertical “today line” 28, one can visually recognize if the work is behind schedule, on schedule, or ahead of schedule. If a project is on schedule, the right edge of a project work performed would be even with the today line. If a project is behind schedule, the right edge of the work performed area would be behind, or to the left of, as looking at the chart, the today line 28. Conversely, if the right edge of a project performed work is ahead of, or to the right of the today line 28, as looking at the chart, the project would be ahead of schedule. This is an intuitive and highly visual measure of schedule performance.

This is illustrated in embodiment 20. In FIG. 4A, one can recognize that projects 40 and 50 are behind schedule. This is due to the right edges 45, 55 of the shading representing work performed 44, 54 are behind the today line 28. Projects 60 and 70 are ahead of schedule due to the right edges 65, 75 being ahead of the today line 28.

The cost performance relative to earned value of a project is also completely enclosed within that project's area of budget costs of work scheduled. The cost performance is represented by two conditions, the budgeted cost of work scheduled and the actual cost of the work performed. As set out above, the budgeted cost of work scheduled is represented as an area chart as a function of time. Likewise, the budgeted cost for work performed is also represented as an area chart as a function of time which is represented within the area chart of the budgeted cost of work scheduled and never exceeds this area.

As a project incurs actual costs, an area chart of the actual costs fills the area chart of budget cost from bottom to top. The amount of the area chart which is filled in is the percentage of actual cost as compared to the budgeted cost. In the event a project is over budget, the area chart of the actual costs fills in from top to down. Further, depending on the level of actual costs being over budget, a different shading or color can be utilized. This allows for the ability to visually determine if the work is under budget, on budget, over budget or extremely over budget.

This is illustrated in FIG. 4A, project 80 is completely painted with a particular shading 83. Since there is no other shading in project 80's area chart 82, one can visually recognize that no actual costs have been incurred with this project 80, which is proper since project 80 was not to have any work performed at this time frame. Project 30 illustrates a project that has been completely performed and has incurred some actual costs. The shading 36 representing the actual costs is illustrated. Further by the nature of shading 36, one can visually recognize that project 30 was completed under budget with the actual cost being approximately ten percent (10%) under the budgeted cost.

Also shown in FIG. 4A, projects 40, 50 and 60 illustrate ongoing projects having some work yet to be performed and at various budget levels. Project 40 is shown to have is a project which illustrates actual cost being approximately thirty percent (30%) under the budgeted cost for the project 40. Project 50 is shown to have actual costs which are over budget in the amount of approximately ten percent (10%) over the budgeted costs. Project 60 is also shown to be over budget as shown by shading 69, but due to the nature of shading 69, it is determined that project 60 is more than one hundred percent (100%) over the budgeted costs.

By layering the schedule performance relative to earned value and cost performance relative to earned value, this aspect of the present invention provides the ability for one to determine if work is on schedule and on budget or not. Further, by having the area of a project's budgeted cost for work scheduled being a function of time, one can track a project's cost and schedule performance over time. This allows the life cycle of the project to be visually represented.

In embodiment 20, FIGS. 4A-E are illustrative. FIG. 4A represents projects 30-80 at a particular time, 5 February. FIG. 4B represents these same projects one week later in time, at 12 February FIGS. 4C-E represents these at progressively later weeks in time.

In FIG. 4A, project 40 is shown to be behind schedule and under budget; project 50 is shown to be behind schedule and slightly over budget and project 60 is shown to be ahead of schedule but extremely over budget. A manager utilizing this embodiment 20 of the present invention would be able to visually recognize the status of these projects and make any necessary adjustment. For example, a manager can reassign resources, such as funding and work force, from project 60, due to it being ahead of schedule and over budget, to project 40, which is under budget and behind schedule.

As shown in FIG. 4B, project 40 is still behind schedule but only by approximately twenty percent (20%). Further, it is still under budget. As for project 60, it is still ahead of schedule and has reduced the amount that it is over budget as illustrated by the shading representing being over budget as contrasted to the extremely over budget shading shown in FIG. 4A.

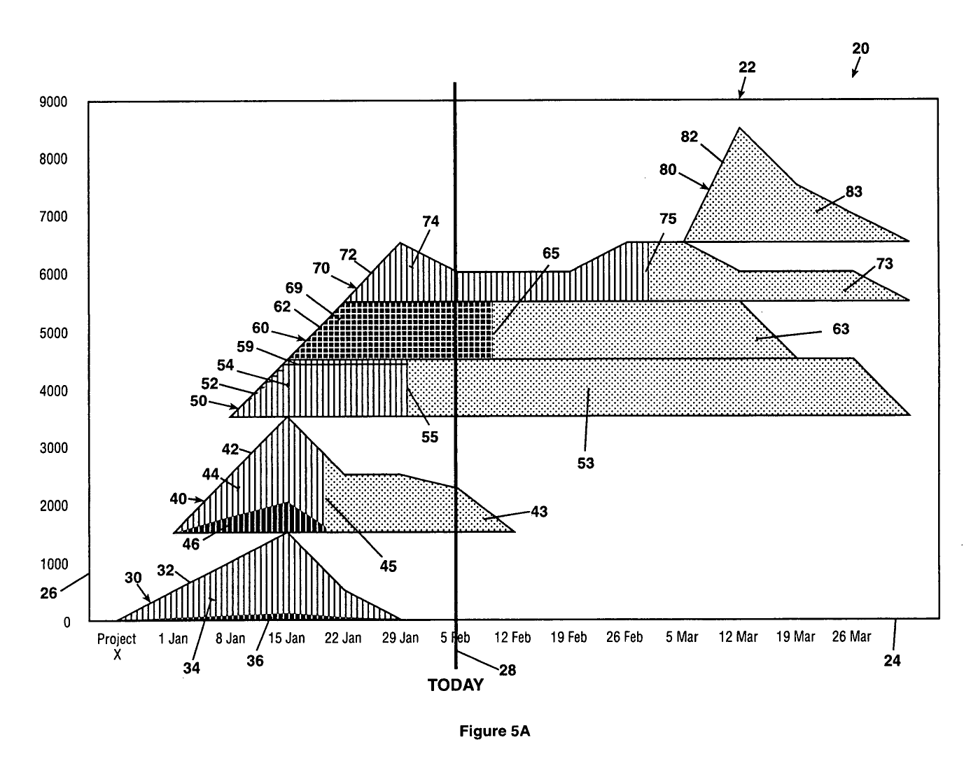

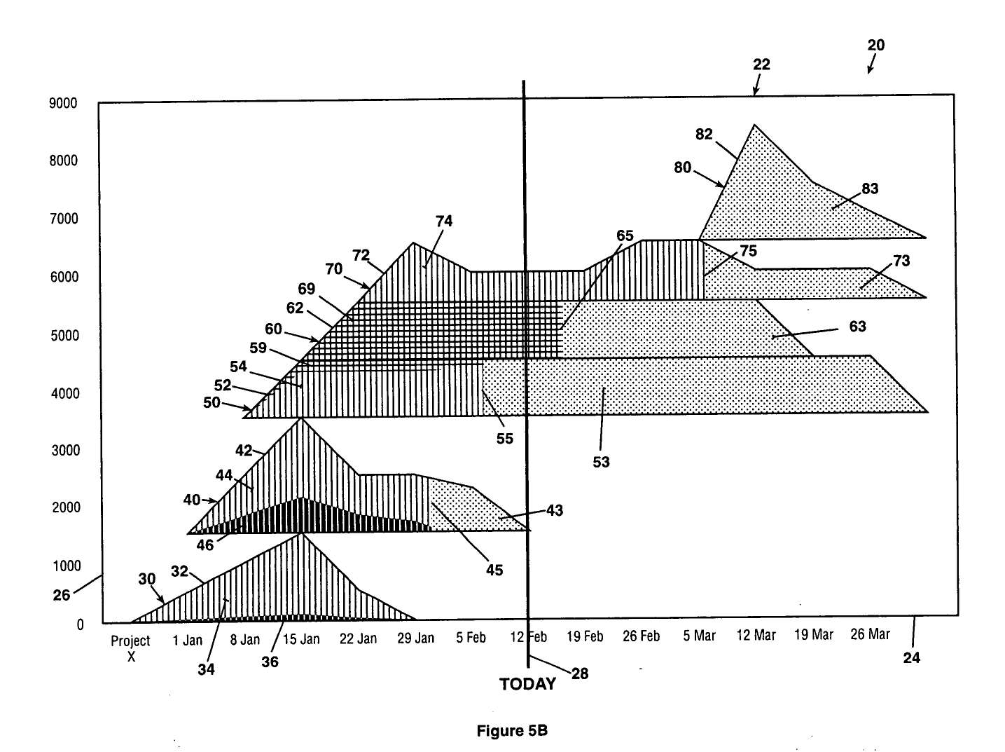

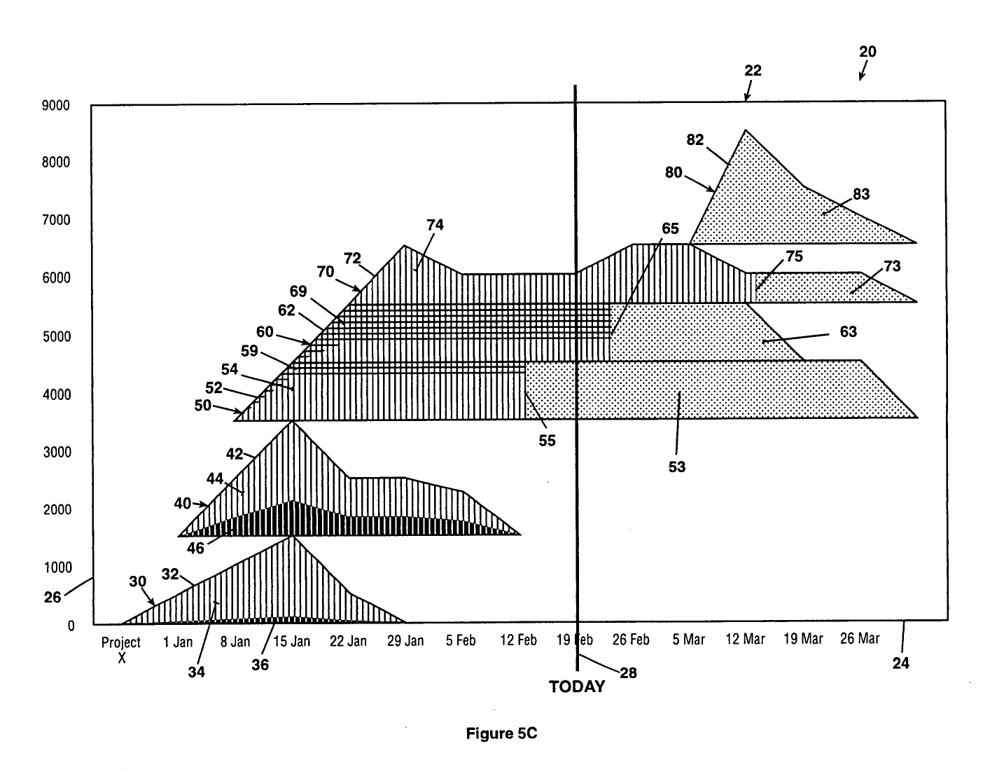

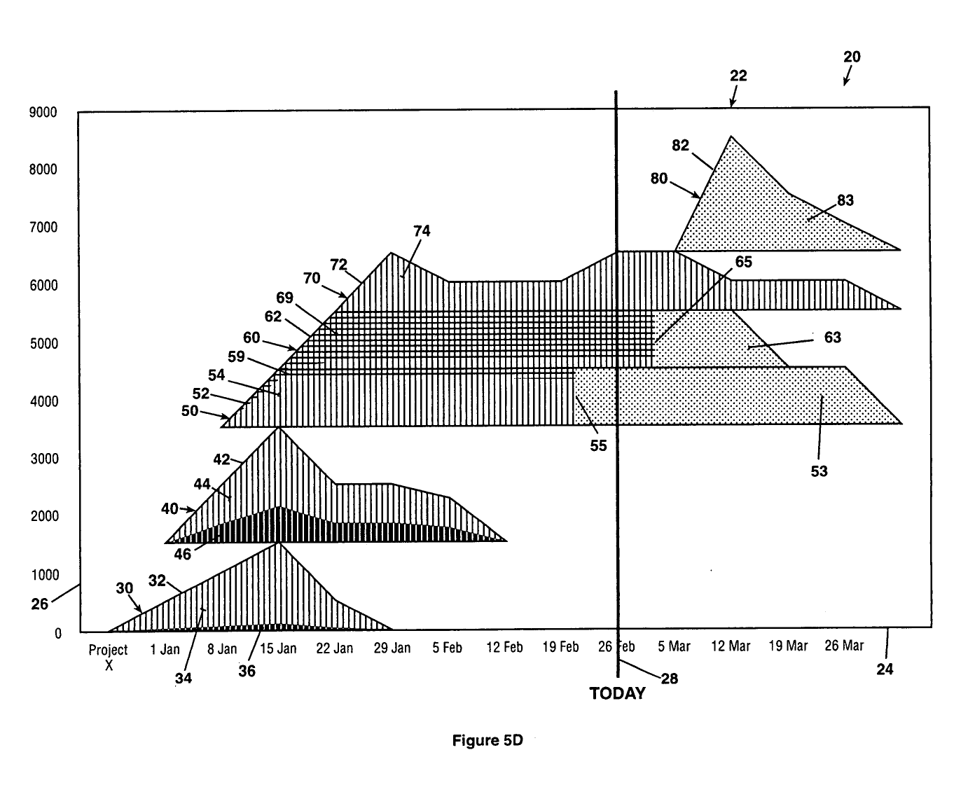

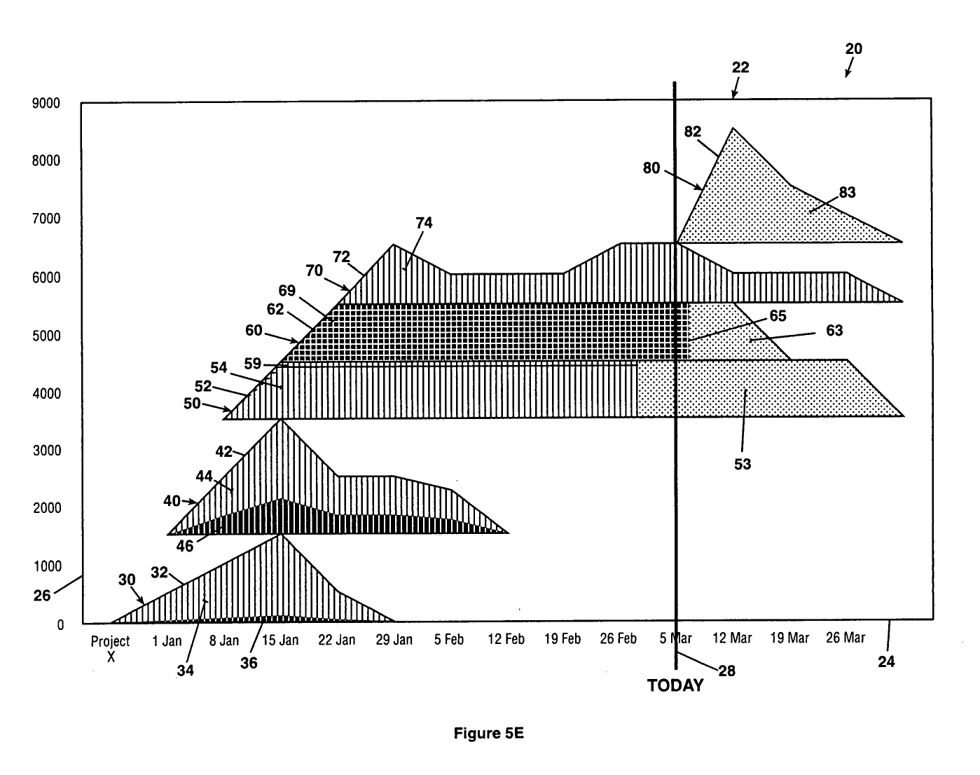

FIGS. 4A-E show embodiment 20 of the present invention in an “aggregate” view, that is budgeted costs all the projects are stacked upon each other. FIGS. 5A-E, however, show the same projects 30-80 of embodiment 20 in a “segregated” view. The segregated view does not stack the project but rather sets each project out independently from the other projects. The shading or colors representing schedule performance and cost performance, however, are the same as with the “aggregate view.”

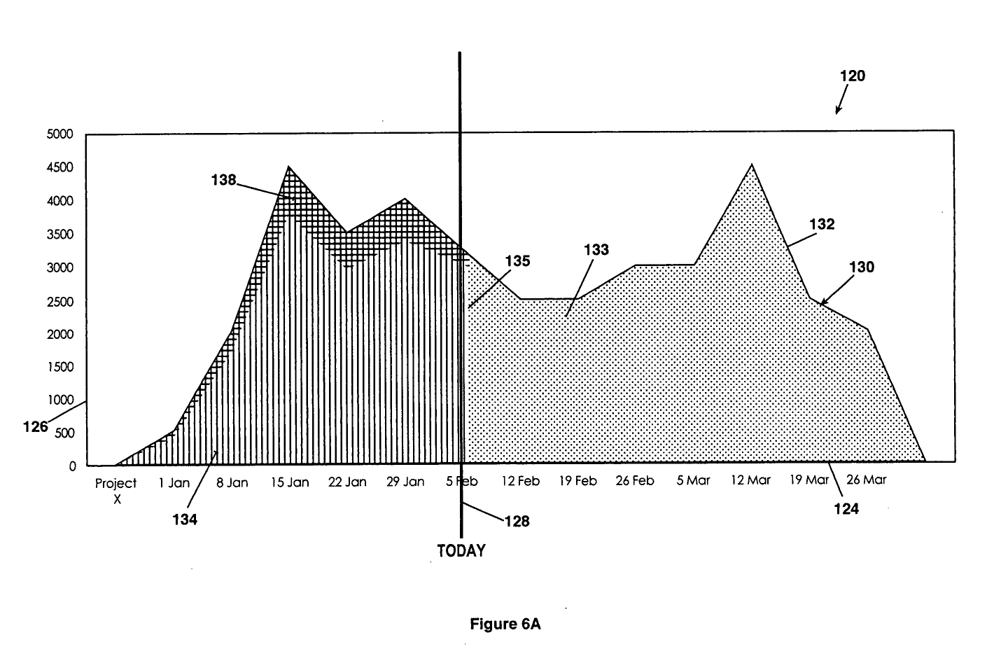

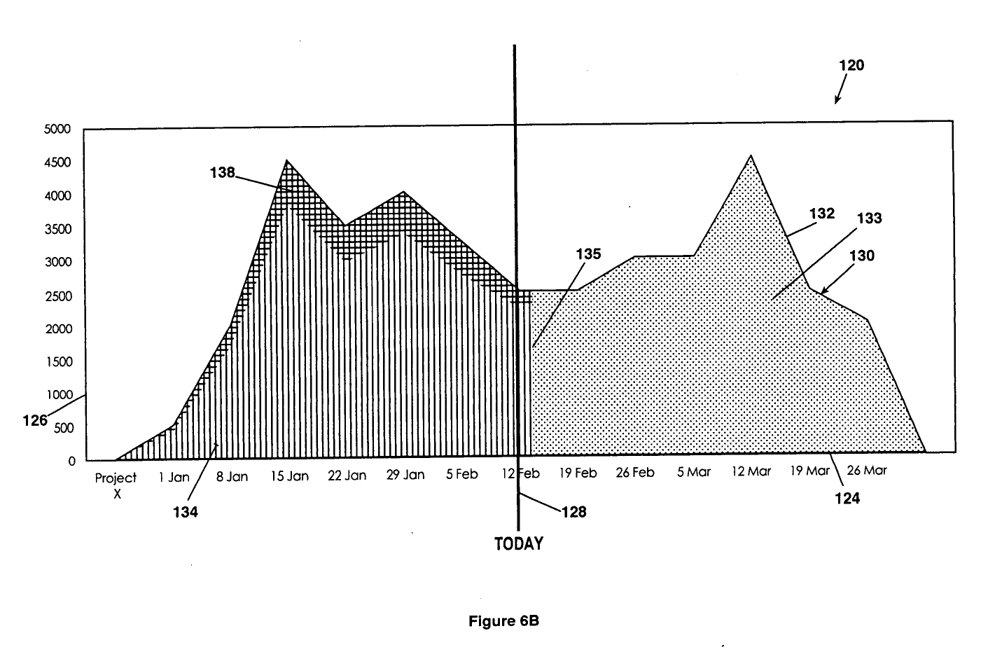

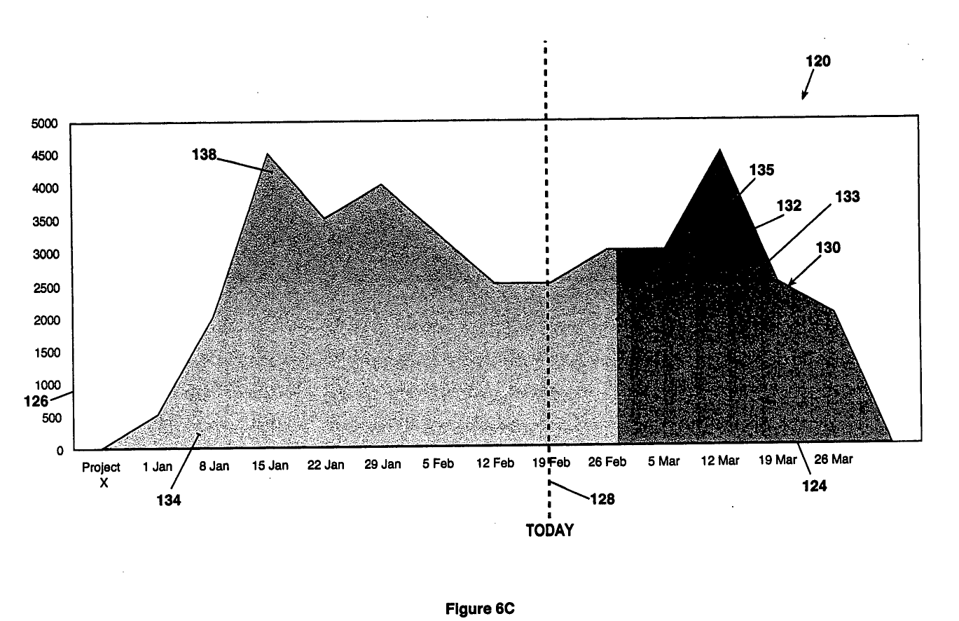

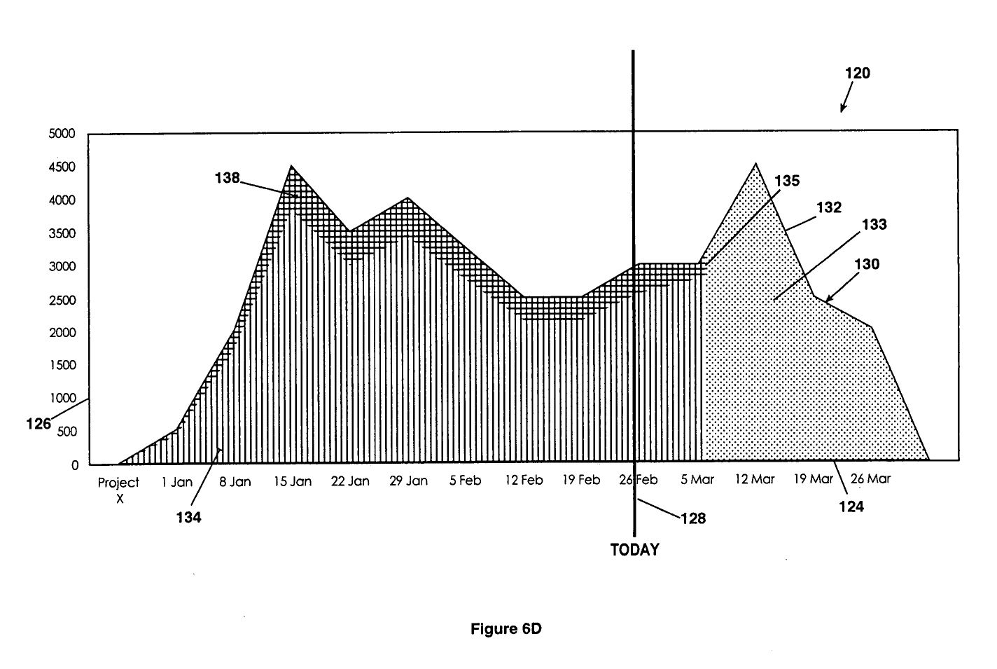

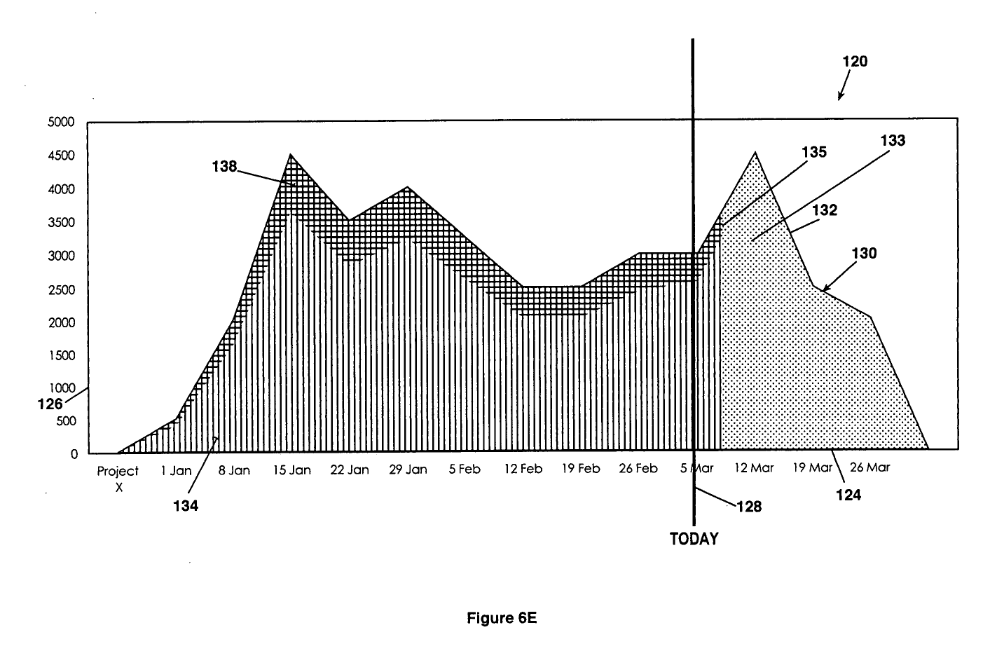

FIGS. 6A-E show an embodiment 120 of the present invention. This embodiment 120 is an “integrated” view of the same projects 30-80 of embodiment 20. This embodiment 120 utilizes the same data as projects 30-80 of embodiment 20 but without the individual project breakdowns. The integrated view can show how a group of projects is performing as a whole. This can be useful in situations where overall knowledge, as compared to individual project knowledge, is useful, such as company wide management or department wide management.

In embodiment 120, the area of the area chart 132 of the integrated projects 130 is the same as the overall area of all the individual projects 30-80 of embodiment 20. This allows for continuity between the differing views.

In embodiment 120, the same shadings used in FIGS. 4A-E and 5A-E showing schedule performance relative to earned value and cost performance relative to earned value are used. In FIG. 6A, the performed work 134 is slightly ahead of the today line 128 and is approximately forty percent (40%) of the scheduled work 133 illustrating the overall schedule performance to be slightly ahead of schedule. Further, the overall actual costs are somewhat over budget as shown by shading 138. As embodiment 120 progresses along in time, as illustrated in FIGS. 6B-E, one can visually recognize the overall performance stays approximately the same with the schedule performance remaining at various amount ahead of schedule and the cost performance remaining at various amounts over budget.

In the present invention, one can use integrated and aggregated views simultaneously, not shown. It is within the scope of the present invention to display a combination of the integrated views and aggregate views in the same display.

Further, it is within the scope of the present invention to display all three views, aggregate, integrated and segregated in a single display utilizing the same today line, horizontal scale and vertical scale. This allows a user to visually observe the status the work performance from a plurality of perspectives.

In another aspect, the above system is implemented by a computer and software program executed by the computer. The software program and computer being operable in combination to receive various work performance data, including the cost performance relative to earned value and the schedule performance relative to earned value; and display the cost performance and the schedule performance in a single, integrated display. The computer and software program is operable to prepare the display as a plurality of layers as described above. One skilled in the art will recognize that the use of a computer and software is illustrative and that the above system can be implemented over a computer network having one or more computers located in connection with or remotely from other computers and by one or more software programs executable by one or more computers.

In another aspect, the present invention discloses a method for managing work including the steps of receiving various work performance data, including the cost performance relative to earned value and the schedule performance relative to earned value; and displaying, simultaneously, said cost performance and said schedule performance in a single, integrated display.

Further, this aspect of the method of the present invention can include displaying the single, integrated display as a plurality of layers having a bottom layer representing budgeted cost for work scheduled, a middle layer representing budgeted cost for work performed and top layer representing actual cost for work performed, as set out above.

While the invention has been described with a certain degree of particularity, it is understood that the invention is not limited to the embodiments set forth herein for purposes of exemplification, but is to be limited only by the scope of the attached claims or including the full range of equivalency to which each element thereof is entitled.

1. A system for managing work, comprising:
a two-dimensional display depicting work performance data including cost performance relative to earned value and the schedule performance relative to earned value, said work performance data is displayed in a plurality of layers including a layer representing budgeted cost for work scheduled, a layer representing budgeted cost for work performed and a layer representing actual cost for work performed.

2. The system of managing work of claim 1 wherein the work performance data includes project work and non-project work.

3. The system of managing work of claim 1 wherein said layer representing budgeted cost for work scheduled is represented as an area chart as a function of time and wherein said layer representing budgeted cost for work performed is represented as an area chart as a function of time, said area of said budgeted cost for work performed never exceeds said area of said budgeted cost for work scheduled and both the area of budgeted cost for work scheduled and the area of budgeted cost of work performed have unique shading or color indicators.

4. The system of managing work of claim 3 wherein said layer representing budgeted cost for work performed is filled left to right with the right edge representing the current achievement of the budgeted cost for work performed and providing a visual determination of whether the scheduled performance is ahead of schedule, on schedule or behind schedule.

5. The system of managing work of claim 4 wherein the display said actual cost for work performed is represented as an area chart that never exceeds said area of said budgeted cost for work performed, said area of actual cost of work performed represented by a plurality of determinably unique shading or color indicators depending on whether the cost performance is under budget, on budget or over budget.

6. The system of managing work of claim 1 wherein the display of said work performance data is selected from one or more of the following group consisting of: a segregated view of multiple sub-elements of work, an aggregated view of multiple sub-elements of work and an integrated view of all sub-elements of work.

7. The system for managing work of claim 1 wherein said work performance data is defined as a plurality of layers including a bottom layer representing budgeted cost for work scheduled, a middle layer representing budgeted cost for work performed and a top layer representing actual cost for work performed.

8. A system for managing work, comprising:
a computer; and
a software program executed by the computer, software program and computer being operable in combination to:
receive work performance data, said work performance data including cost performance relative to earned value and the schedule performance relative to earned value; and
display cost and schedule performance.

9. The system of managing work of claim 8 wherein said software program and said computer are further operable to prepare said display of said work performance data in a single, integrated display.

10. The system of managing work of claim 8 wherein said software program and said computer are further operable to prepare said work performance data in a single, integrated display being represented by a plurality of layers comprising:
a bottom layer representing budgeted cost for work scheduled;
a middle layer representing budgeted cost for work performed; and
a top layer representing actual cost for work performed.

11. The system of managing work of claim 10 wherein said software program and said computer are further operable to display said budgeted cost for work scheduled as an area chart as a function of time and said budgeted cost for work performed as an area chart as a function of time, said area of said budgeted cost for work performed never exceeds said area of said budgeted cost for work scheduled and both the area of budgeted cost for work scheduled and the area of budgeted cost of work performed have unique shadings or colors.

12. The system of managing work of claim 11 wherein said software program and said computer are further operable to fill said display of said budgeted cost for work performed from left to right with the right edge representing the current achievement of the budgeted cost for work performed whereby providing a visual determination of whether the scheduled performance is ahead of schedule, on schedule or behind schedule.

13. The system of managing work of claim 12 wherein said software program and said computer are further operable to display said actual cost for work performed as an area chart that never exceeds said area of said budgeted cost for work performed, said area of actual cost of work performed is represented by a plurality of determinably unique shading or color indicators depending on whether the cost performance is under budget, on budget or over budget.

14. The system of managing work of claim 10 wherein said software program and said computer are further operable to display of said work performance data from one or more of the following group consisting of: a segregated view of multiple sub-elements of work, an aggregated view of multiple sub-elements of work and an integrated view of all sub-elements of work.

15. A method for managing work, comprising the steps of:
receiving work performance data, said work performance data including cost performance relative to earned value and the schedule performance relative to earned value; and
displaying cost and schedule performance in a single, integrated display.

16. The method of managing work of claim 15 wherein said work performance data includes project work and non-project work.

17. The method of managing work of claim 16 wherein said step of displaying the single, integrated display is further defined as displaying said work performance data in a plurality of layers comprising:
a layer representing budgeted cost for work scheduled;
a layer representing budgeted cost for work performed; and
a layer representing actual cost for work performed.

18. The method of managing work of claim 17 wherein the step of displaying said work performance data is further defined as displaying said budgeted cost for work scheduled as an area chart as a function of time and said budgeted cost for work performed as an area chart as a function of time, said area of said budgeted cost for work performed never exceeds said area of said budgeted cost for work scheduled and both the area of budgeted cost for work scheduled and the area of budgeted cost of work performed have unique shadings or colors.

19. The method of managing work of claim 18 wherein the step of displaying said budgeted cost for work performed is defined as filling said area of budgeted cost of work performed from left to right with the right edge representing the current achievement of the budgeted cost for work performed whereby providing a visual determination of whether the scheduled performance is ahead of schedule, on schedule or behind schedule.

20. The method of managing work of claim 19 wherein said actual cost for work performed is displayed as an area chart that never exceeds said area of said budgeted cost for work performed, said area of actual cost of work performed is represented by a plurality of shadings or colors depending on whether the cost performance is under budget, on budget or over budget.

21. The method of managing work of claim 17 wherein the step of displaying said work performance data from one or more of the following group consisting of: a segregated view of multiple sub-elements of work, an aggregated view of multiple sub-elements of work and an integrated view of all sub-elements of work.
